(19) United States
(12) Patent Application Publication
(10) Pub. No.: US 2026/0351092 A1
(43) Pub. Date: Nov. 5, 2026

(54) Platform for Fantasy Sports Contests

(71) Applicant: Trey Terry Daubert, Allentown, PA (US)

(72) Inventor: Trey Terry Daubert, Allentown, PA (US)

(21) Appl. No.: 19/384,834

(22) Filed: Nov. 10, 2025

Related U.S. Application Data
(60) Provisional application No. 63/718,178, filed on Nov. 8, 2024.

(51) Int. Cl. G07F 17/32

(52) U.S. Cl. CPC G07F 17/3288; G07F 17/3244; G07F 17/3276

(57) ABSTRACT

Systems and methods for providing bets on sports contests in a platform are provided. The platform allows users to place fantasy bets and wagers on various sports contests without the risk of losing actual money by gambling. Users create and maintain an account on the platform. After an initial purchase to opt into a contest, users are given a plurality of tokens to wager. Said tokens are replenished separately for each contest that the user chooses to opt in. Users can place various bets and wagers on the outcomes within a contest. Bets vary depending on the type of sport or game that the contest is over. After a determined amount of time, whichever user possessing the most amount of tokens within a contest wins that contest. Unused tokens cannot be transferred from one contest to another.

### FIELD OF THE INVENTION

The present invention relates generally to sports betting and fantasy sports contests. Particularly, the present invention is a platform for fantasy sports contests that allows users to place fantasy bets and wagers on various sports contests without the risk of losing actual money by gambling.

### BACKGROUND OF THE INVENTION

Fantasy contests, such as fantasy football, fantasy basketball, etc., are a form of popular gaming amongst fans. Fans of a sport draft and manage their own fantasy teams of players to compete in fantasy leagues against friends, creating an aspect of involvement between the fan and professional athletes and teams. In these fantasy leagues, it is very common for participants to include buy-in payments and cash prizes for the winners with real money. For this reason, fans become more than spectators as the outcomes of professional sports contests affect the outcomes of fantasy league contests. Fantasy contests demonstrate the desire of sports fans to increase the amount of interaction and investment they may have to a particular player, team, or sport as a whole.

Sports betting is a widely popular gambling practice. Bettors wager real money on the outcomes of sports contests. Such bets are available to be placed in casinos, placing sports betting both physically and figuratively adjacent to traditional gambling. While sports betting can be exhilarating to many fans, there is an inherent danger within any gambling that risks the bettor's money. While it is possible to see gains of money, it is also possible, if not likely, to see losses of money when sports betting. Like traditional gambling, sports betting can be a dangerous practice to many bettors who are otherwise simply enthusiastic sports fans, especially for those prone to gambling addiction. There exists a need to fill the excitement of sports betting while reducing or removing the financial risk for participants.

An objective of the present invention is to reduce or entirely remove the financial risk of gambling and sports betting for users. Unlike any existing platforms, the present invention allows users to judge who is the best gambler against each other without the risk of losing actual money. By providing a platform that operates on wagered tokens, the present invention does not allow users to wager their actual money. The present invention seeks to provide a “non-alcoholic beer” alternative to existing sports betting and gambling with reduced or removed risk.

Another objective of the present invention is to combine fantasy contests with sports betting to provide a platform for fantasy sports betting. The present invention allows users to place bets on contest outcomes like sports betting from within a fantasy league. Users are able to compete against other users to judge who is the best gambler. Accordingly, the present invention comprises various embodiments across many types of contests and sports. The platform accounts for a wide selection of games depending on the user's interests as a fan.

### SUMMARY OF THE INVENTION

Systems and methods for providing bets on sports contests in a platform are provided. The platform allows users to place fantasy bets and wagers on various sports contests without the risk of losing actual money by gambling. Users create and maintain an account on the platform. After an initial purchase to opt into a contest, users are given a plurality of tokens to wager. Said tokens are replenished separately for each contest that the user chooses to opt in. Users can place various bets and wagers on the outcomes within a contest. Bets vary depending on the type of sport or game that the contest is over. After a determined amount of time, whichever user possessing the most amount of tokens within a contest wins that contest. Unused tokens cannot be transferred from one contest to another.

### BRIEF DESCRIPTION OF THE DRAWINGS

FIG. 1 is a graphical user interface of the present invention.

FIG. 2 is a graphical user interface of the present invention.

FIG. 3 is a graphical user interface of the present invention.

FIG. 4 is a graphical user interface of the present invention.

FIG. 5 is a graphical user interface of the present invention.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header. All illustrations of the drawings are for the purpose of describing selected versions of the present invention and are not intended to limit the scope of the present invention. The present disclosure includes many aspects and features. Moreover, while many aspects and features relate to, and are described in the context of the disclosed use cases, embodiments of the present disclosure are not limited to use only in this context.

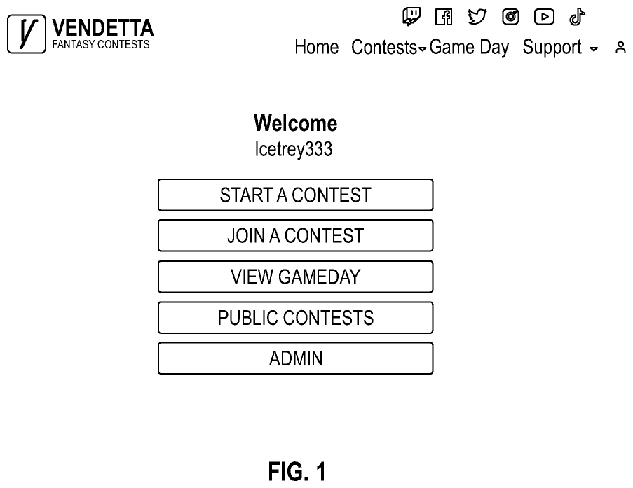

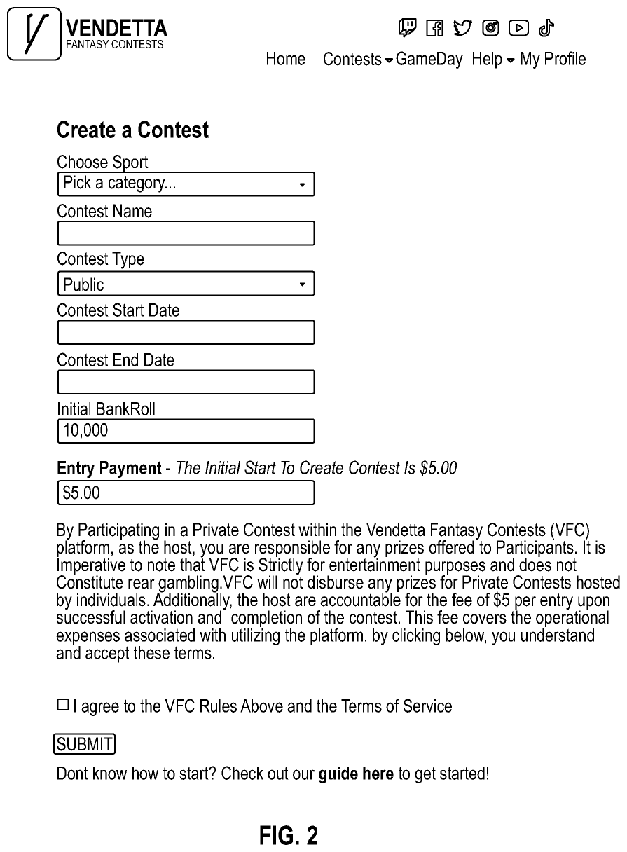

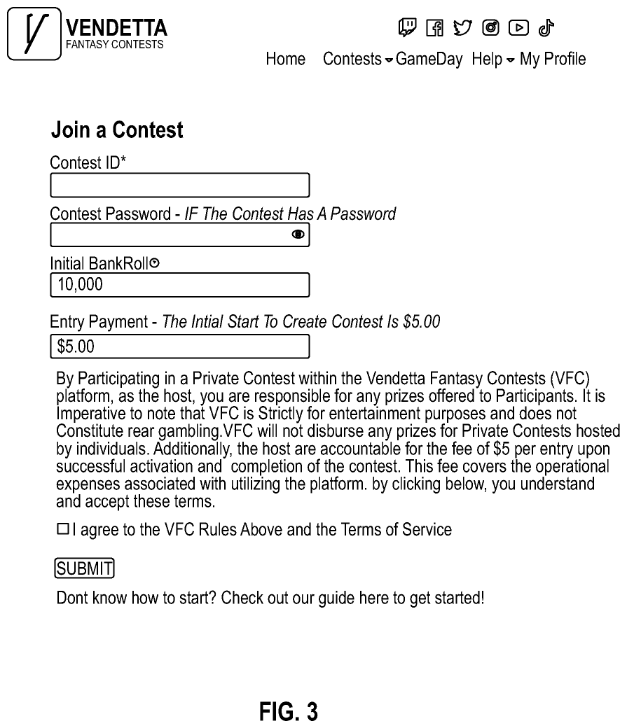

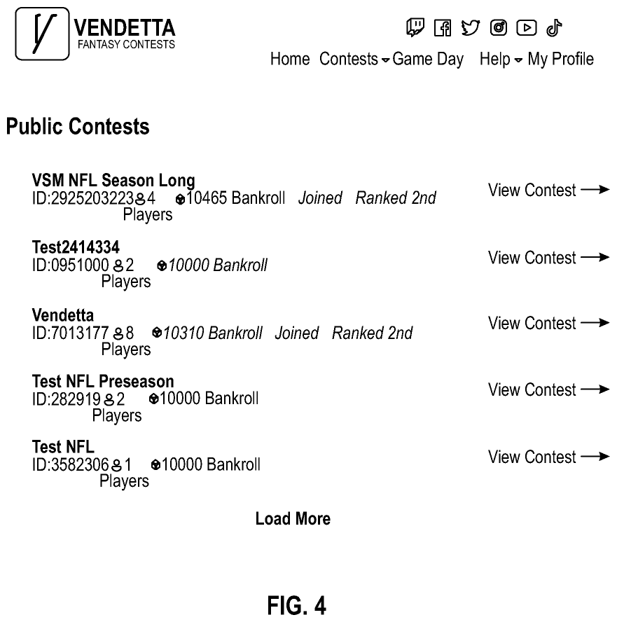

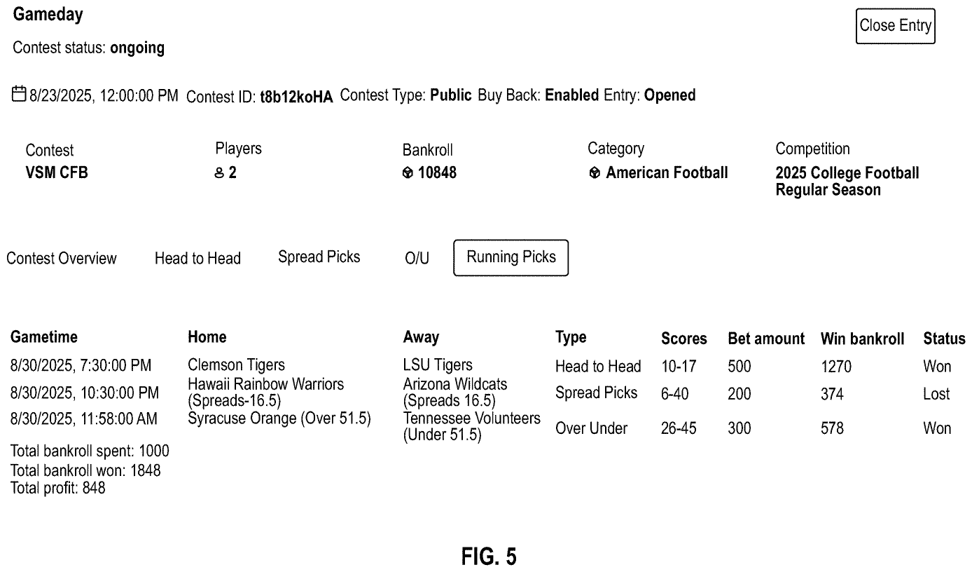

Systems and methods for providing bets on sports contests in a platform are provided. As shown in FIG. 1-5, the present invention comprises a platform for fantasy sports contests that allows users to place fantasy bets and wagers on various sports contests without the risk of losing actual money by gambling. The present invention comprises a plurality of contests, a plurality of tokens, the ability to create and join contests, the capability to place bets and wagers on the outcomes of a contest using said tokens, and customizable profiles.

Users of the present invention create and maintain an account on the platform. After an initial purchase to opt into a contest, users are given a plurality of tokens to wager. Said tokens are replenished separately for each contest that the user chooses to opt in. Users can place various bets and wagers on the outcomes within a contest. Bets vary depending on the type of sport or game that the contest is over. In the preferred embodiment of the present invention, a contest is determined by its win/loss outcome. Unlike existing prior art, the present invention does not judge contests based on fantasy “stats” or points (e.g. yards, catches, rosters, etc.). After a determined amount of time, whichever user possessing the most amount of tokens within a contest wins that contest. Unused tokens cannot be transferred from one contest to another.

In some embodiments, if a user runs out of tokens during a contest, a buyback period may be available. If a buyback option is available, a user can purchase a new amount of tokens. If the buyback option is unavailable for an ongoing contest, a user can create or join a new contest instead. By not always providing the option to buyback, the present invention teaches users who run out of tokens when they should proceed with more caution, especially in other gambling scenarios betting money instead of tokens.

Users have the option to join a plurality of contests. Various embodiments of the present invention exist to encapsulate a wide range of games or competitions. In the preferred embodiment of the present invention, said plurality of contests comprises various games, including: baseball; hockey; football; basketball; soccer; the Olympics; archery; breakdancing; color guard; competitive dance; cheerleading; figure skating; track events; racing, such as Nascar or Indy Car; canoe sprint; boxing; MMA; curling; water polo; competitive swimming; diving; esports; softball; wiffleball; cricket; field hockey; wrestling; sumo wrestling; the Paralympics; flag football; rugby; golf; mini-golf; handball; pickleball; dodgeball; lacrosse; ping-pong; badminton; tennis; volleyball; squash; racquetball; the X Games; skateboarding; snowboarding; surfing; dog sports; competitive climbing; gymnastics; cycling; WWE; slap boxing; fencing; disc golf; music awards; powerlifting; horse racing; fishing; hunting; bullriding; poker; competitive card game tournaments; board game competitions; javelin discus; hammer throw; shot put; rowing; CrossFit; tug of war; chess; air hockey; beer pong; checkers; Connect Four; dominoes; cornhole; Scrabble; Monopoly; bocce; bowling; shuffleboard; ring toss; croquet; darts; axe throwing; Skee-Ball; pool; horseshoe; paintball; kickball; marching band; competitive math; competitive eating; arm wrestling; the NFL Draft; the NBA Draft; the NHL Draft; the MLB Draft; free agency props; sailing; high jump; hurdles; and jumping events. The present invention contemplates the further addition of games as more games become available over time. Although each contest may operate differently, the present invention allows users to place bets and wagers in the same way regardless of the game's scoring or outcomes.

In the preferred embodiment of the present invention, users have the ability to place bets across multiple games within a contest. Said contests can involve crossplay and are not limited to one game per contest.

In the preferred embodiment of the present invention, users are able to see other users' picks and selections. This visibility adds a layer of gamesmanship between users and encourages attention to strategy. The ability to see public picks of other users also provides the opportunity to evaluate where a user may have chosen correctly or wrongly.

In the preferred embodiment of the present invention, the present invention comprises a plurality of bets, such as parlay bets and prop bets.

The present invention allows users to create and customize a profile. Users can connect with each other through said profiles to create and join contests. The amount of participating users can be determined at the time of creating a contest. There is no built-in maximum amount of users that can join a contest. For this reason, the present invention facilitates maximum participation from users, unlike existing fantasy contest platforms that have a limiting maximum amount of players who can join per league.

In the preferred embodiment, said contests can be created as either public or private. Users may join public contests to bet and wager against any other participating user. Users may otherwise restrict a contest to a private group if a select group of players is desired, requiring a group password. The user who hosts a contest determines how long the contest will last. Examples of possible durations include a regular season, playoffs, or any other particular range of time.

In some embodiments, users are provided additional rewards in the form of karma points or reward points. In the preferred embodiment of the present invention, users are rewarded for playing or gambling responsibly in the form of karma points or reward points, Although said tokens are not transferred from one content to another, said reward points can be saved for future contests for various benefits or value.

The present invention further comprises a frontend user interface, a backend scoring engine, and a backend database. Said frontend user interface provides data to said backend scoring engine and said backend database. Said data includes users' bets, win/loss outcomes of contests, and user history of previous win/loss outcomes. Said backend scoring engine further comprises an administrator panel and manual override access. An administrator can use said administrator panel to manually correct any errors including erroneous bets, erroneous contest outcomes, or erroneous standings. Said frontend user interface displays the status for recent, ongoing, or future sports contests and users' total amount of tokens.

Although the invention has been explained in relation to its preferred embodiment, it is to be understood that many other possible modifications and variations can be made without departing from the spirit and scope of the invention.

What is claimed is:

1. A method for providing bets on sports contests comprising:
providing a first plurality of tokens to a user;
associating at least one user with a first sports contest;
accepting first bets from said at least one user in relation to prospective win/loss outcomes of said first sports contest using said first plurality of tokens;
storing said first bets in a backend database;
calculating results of said first bets in relation to actual win/loss outcomes of said first sports contest;
dispensing payouts of said first plurality of tokens to said at least one user based on said bets in relation to actual win/loss outcomes of said first sports contest; and
generating user standings based on said results of said bets in relation to actual win/loss outcomes of said first sports contest and total amount of said first plurality of tokens.

2. The method for providing bets on sports contests of claim 1,
wherein said at least one user is a plurality of users, further comprising:
updating standings of said plurality of users in real time based on said first bets in relation to actual win/loss outcomes of said first sports contest.

3. The method for providing bets on sports contests of claim 1, further comprising:
manually correcting errors using manual override access, and
automatically updating said user standings after said errors are manually corrected.

4. The method for providing bets on sports contests of claim 1, further comprising:
providing additional first plurality of tokens to a user.

5. The method for providing bets on sports contests of claim 1, further comprising:
providing a second plurality of tokens to a user;
associating at least one user with a second sports contest;
accepting second bets from said at least one user in relation to prospective win/loss outcomes of said second sports contest using said second plurality of tokens;
storing said second bets in a backend database;
calculating results of said second bets in relation to actual win/loss outcomes of said second sports contest; and
dispensing payouts of said second plurality of tokens to said at least one user based on said bets in relation to actual win/loss outcomes of said second sports contest;
generating user standings based on said results of said second bets in relation to actual win/loss outcomes of said second sports contest and total amount of said second plurality of tokens;
wherein said first plurality of tokens cannot be used to place bets on a second sports contest; and
wherein said second plurality of tokens cannot be used to place bets on a first sports contest.

6. The method for providing bets on sports contests of claim 5,
wherein said at least one user is a plurality of users, further comprising:
updating standings of said plurality of users in real time based on said second bets in relation to actual win/loss outcomes of said second sports contest.

7. The method for providing bets on sports contests of claim 5, further comprising:
manually correcting errors using manual override access, and
automatically updating said user standings after said errors are manually corrected.

8. The method for providing bets on sports contests of claim 5, further comprising:
providing additional first plurality of tokens to a user; and
providing additional second plurality of tokens to a user.

9. A method for providing bets on sports contests comprising:
providing a first plurality of tokens to a user;
associating at least one user with a first sports contest;
accepting first bets from said at least one user in relation to prospective win/loss outcomes of said first sports contest using said first plurality of tokens;
storing said first bets in a backend database;
calculating results of said first bets in relation to actual win/loss outcomes of said first sports contest;
dispensing payouts of said first plurality of tokens to said at least one user based on said bets in relation to actual win/loss outcomes of said first sports contest;
generating user standings based on said results of said bets in relation to actual win/loss outcomes of said first sports contest and total amount of said first plurality of tokens;
providing a second plurality of tokens to a user;
associating at least one user with a second sports contest;
accepting second bets from said at least one user in relation to prospective win/loss outcomes of said second sports contest using said second plurality of tokens;
storing said second bets in a backend database;
calculating results of said second bets in relation to actual win/loss outcomes of said second sports contest;
dispensing payouts of said second plurality of tokens to said at least one user based on said bets in relation to actual win/loss outcomes of said second sports contest; and
generating user standings based on said results of said second bets in relation to actual win/loss outcomes of said second sports contest and total amount of said second plurality of tokens;
wherein said first plurality of tokens cannot be used to place bets on a second sports contest; and
wherein said second plurality of tokens cannot be used to place bets on a first sports contest.

10. The method for providing bets on sports contests of claim 9,
wherein said at least one user is a plurality of users, further comprising:
updating standings of said plurality of users in real time based on said first bets in relation to actual win/loss outcomes of said first sports contest; and
updating standings of said plurality of users in real time based on said second bets in relation to actual win/loss outcomes of said second sports contest.

11. The method for providing bets on sports contests of claim 9, further comprising:
manually correcting errors using manual override access, and
automatically updating said user standings after said errors are manually corrected.

12. The method for providing bets on sports contests of claim 9, further comprising:
providing additional first plurality of tokens to a user; and
providing additional second plurality of tokens to a user.

13. The method for providing bets on sports contests of claim 9, further comprising:
providing additional rewards to a user based on said user's standings.

14. A system for providing bets on sports contests, comprising:
a plurality of sports contests,
a plurality of tokens,
a frontend user interface,
a backend scoring engine, and
a backend database,
wherein said frontend user interface provides data to said backend scoring engine and said backend database.

15. The system for providing bets on sports contests of claim 14, further comprising:
an administrator panel, and
manual override access,
wherein said manual override access provides a means to edit said data.

16. The system for providing bets on sports contests of claim 14,
wherein said data further comprises bets from at least one user in relation to prospective win/loss outcomes of at least one sports contest using said tokens;
wherein said data further comprises actual win/loss outcomes of at least one sports contest; and
wherein said data further comprises history of previous win/loss outcomes of sports contests.

17. The system for providing bets on sports contests of claim 14, further comprising:
customizable profiles,
wherein said frontend user interface further comprises means for displaying a user's profile.

18. The system for providing bets on sports contests of claim 14,
wherein said frontend user interface further comprises means for displaying the status for recent, ongoing, or future sports contests.

19. The system for providing bets on sports contests of claim 14,
wherein said frontend user interface further comprises means for displaying a user's total amount of said plurality of tokens.

20. The system for providing bets on sports contests of claim 14,
wherein said frontend user interface further comprises means for displaying users' bets.
